(19) United States
(12) Patent Application Publication
(10) Pub. No.: US 2005/0073569 A1
(43) Pub. Date: Apr. 7, 2005

(54) Output surfaces for a printing system

(76) Inventors: Roberto Obregon, Jal (MX); Paul Mui, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/679,781

(22) Filed: Oct. 6, 2003

(51) Int. Cl. B41J 2/01

(52) U.S. Cl. 347/104

(57) ABSTRACT

A printing system is described that may incorporate a plurality of output surfaces, wherein each of the plurality is attached to a mounting surface running substantially perpendicular to a height of the printing system and is offset horizontally from one another, and wherein each of the plurality is shaped to provide user access to printed output.

### DESCRIPTION OF RELATED ART

Printing devices have grown in quality and availability, such that the large, main central printers of the past are now frequently replaced by high-quality compact printers with a small-enough footprint to be placed at each employee's desk or group of desks. The footprint of a printer is generally considered the desk or floor space required for the printer. The increased quality coupled with the affordability of such printers create the possibility for better, more-affordable printing solutions for all manner of homes and businesses.

As technology continues to increase, the ability to package several different functions into a printing device creates even more opportunity to combine fax, scanner, copier, and printer capabilities into a single Multi-Function Product (MFP). MFPs typically handle a combination of documents that come from various sources. Some printed sheets may come from the fax, others may be copies, while some may be printed pages from a remote computer.

Many MFPs store all printed documents in one output bin or tray or on an output surface. This is generally acceptable if there is only one user. In a shared environment, more than one user may have access to the device and the previously stored documents may be easily mixed up. Source-mixing, i.e., mixing the output from multiple sources on the same output surface, may cause one user to inadvertently take away another user's document. Source mixing may exist not only in MFP devices, but in printers that may be shared by more than one user.

### BRIEF DESCRIPTION OF THE DRAWINGS

FIG. 1 is a side elevation illustrating a printing device configured with one embodiment of a horizontal output array, as described herein;

FIG. 2 is a perspective view illustrating a printing device configured with another embodiment of a horizontal output array, as described herein; and

FIG. 3 is a perspective view illustrating a printing device configured with another embodiment of a horizontal output array, as described herein.

### DETAILED DESCRIPTION

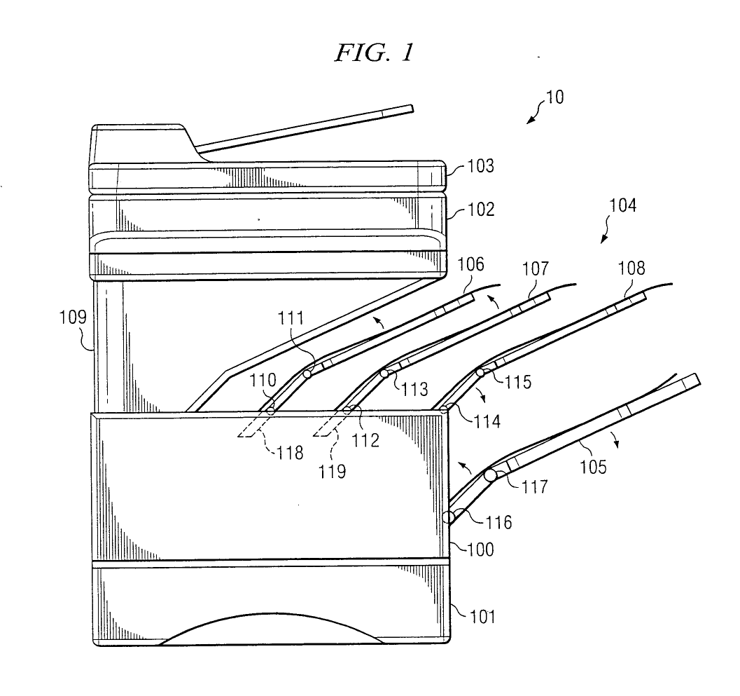

FIG. 1 is a side elevation illustrating printing device 10 configured with one embodiment of horizontal output array 104, as described herein. Printing device 10 includes print engine 100, input cassette 101, scanner 102, and ADF 103. However, instead of providing a vertical array of output trays, printing device 10 is configured with horizontal output array 104, in which each of output trays 105-108 are staggered horizontally from each other or have some kind of horizontal separation. Output trays 106-108 are placed in an output region of printing device 10 attached to a mounting surface. The output region is typically a space within printing device 10 defined around the mounting surface that runs substantially perpendicular to the height of printing device 10. Other features, such as finisher 109, may also be situated within the output region.

Printing device 10 also includes high capacity output tray 105 which is vertically, as well as horizontally, offset from horizontal output array 104. Output trays 105-108 are each horizontally separated from their attachment to print engine 100. In the embodiment illustrated in FIG. 1, output trays 105-108 are shown being attached or configured at an angle with respect to the horizontal in order to allow the printed media to slide more easily on the output surface. The horizontal separation of output trays 105-108 allows print engine 100 to selectively deposit its output into the desired location. Thus, printing device 10 achieves job separation without expending considerable vertical spacing.

In operation, printing device 10 may print the sheets at print engine 100 and then convey the printed media to horizontal output array 104 by a series of rollers, belts, pushers and/or end effectors within print engine 100 (not shown). Appropriate signals may tell printing device 10 where to divert the printed media within the paper path, in order to deposit the document at the correct one of output trays 105-108. These signals may be produced by a computer program in which the customer has stated the criteria to be used for the document separation. In this way, it is possible to send the documents of a certain type to one of output trays 105-108, and the documents of a different type to another of output trays 105-108. For example, the printed media may be sent to output tray 106, the copied media to output tray 107, and the documents received by fax may be sent to output tray 108. Any number of different combinations of print output diversion may be configured in various embodiments of the present printing system.

The present printing system proposes various embodiments utilizing horizontal arrays of two or more output bins. Various embodiments configure the output bins or trays to be substantially parallel and placed in the space between print engine 100 and scanner 102. It is also possible that horizontal output array 104 extends beyond print engine 100, as shown in FIG. 1, or may be placed below print engine 100, above scanner 102, or to any side of printing device 10. In embodiments where an output array extends beyond the footprint of the printer, the output trays may be retractable or movable. For example, output trays 105-108 are shown with hinges 110-117. If a user desires to fold up any of output trays 105-108, the hinges allow output trays 105-108 to be folded up to minimize the parts extending beyond the footprint. Furthermore, output trays 106 and 107 incorporate retracting slots 118 and 119, into which output trays 106 and 107 may be retracted in order to accommodate further folding. It should be noted that any number of different folding or retracting configurations may be implemented depending on the configuration of the overall printing system.

In another embodiment of printing device 10 there may be intermediate operations on the printed media, such as flipping the media, accumulating media jobs for stapling, or the like accumulating each sheet at a temporary place to perform a finishing operation like stapling, punching, stitching, binding and the like. Such operations may occur in finisher 109. Once the intermediate operation in finisher 109 has been completed, then the document may be transported to one of the output bins for temporary storage. Finally, the user picks up the completed document from either of the destination bins, output trays 105-108, where he/she knows that it is.

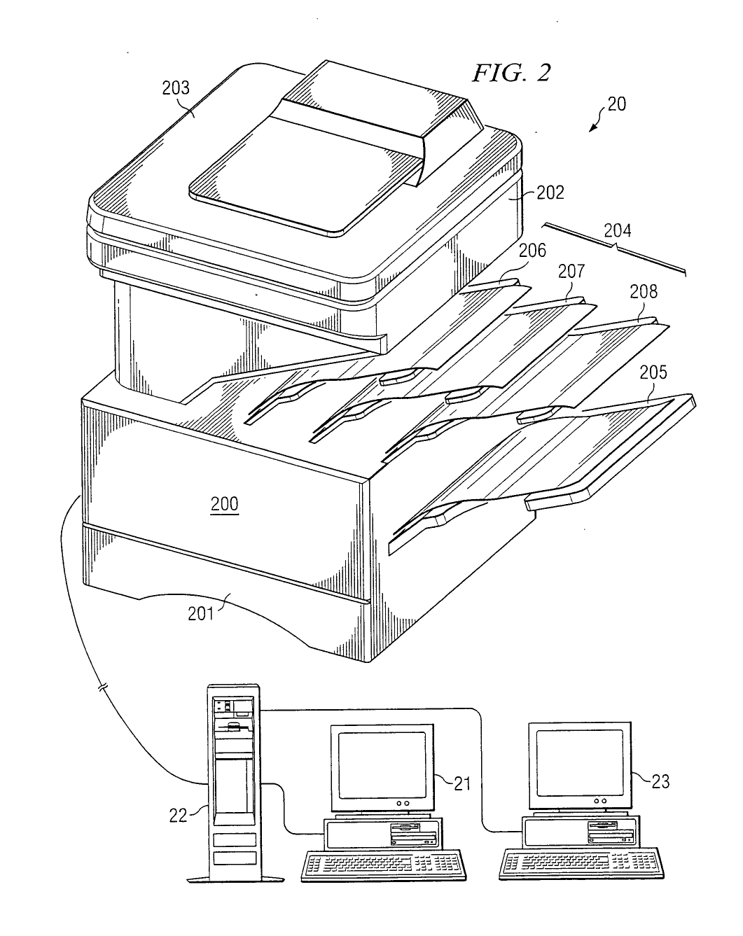

FIG. 2 is a perspective view illustrating printing device 20 configured with another embodiment of horizontal output array 204, as described herein. Printing device 20 may incorporate print unit 200, paper tray 201, scanning unit 202, and automatic document feeder (ADF) 203. It also may include horizontal output array 204 and large capacity output surface 205 configured for side-access or side-orientation, of printing device 20, instead of front-access or front-orientation, as shown in FIG. 1. Each of output surfaces 205-208 of horizontal output array 204 may present printing device 20 output to users on the side of printing device 30. FIG. 2 depicts an additional configuration of a printer, MFP, or other printing device with a horizontally-arrayed set of output trays or surfaces. It should be noted that many different configurations may be implemented on different printers, MFPs, or printing devices.

The various embodiments of the present solution offer an ergonomic approach to the problem of job separation by allowing different users to retrieve their jobs from an acceptable height without the need to position any one or a number of the printing device's elements too high vertically, which may cause a stability issue. The various embodiments may be configured to have the output array be front, side, or even rear-oriented. The orientation of the output array actually allows a flexible ability to situate the printing system. It therefore optimizes the space, which is a limited resource in most offices.

The printing device or MFP configured with such horizontal output array embodiments may provide for sending particular output to specific trays or surfaces. Therefore, referring to FIG. 2, each of output bins 205-208 can be used for different types of printing. For example, a user at computer 21 may select to print output to output surface 208. The user-selection of output surface 208 may then be communicated to printing device 20 through print server 22. In response to the user-selection, output received from the user at computer 21 may be printed to output surface 208, while output received from other users may be blocked from printing to output surface 208. Additional embodiments may be programmed by users or system administrators through print server 22 to designate stapled print jobs for output surface 206, collated print jobs for output surface 207, and regular print jobs for output surface 208, thus, addressing some of the issues associated with source-mixing.

In an additional configuration, a user at computer 21 and a user at computer 23 may each send a print job to printing device 20. Instead of placing the output for each of the jobs on one output surface, printing device 20 may place the output from computer 21 on output surface 208, while the output from computer 23 may be placed on output surface 207. In this manner of operation, the chance at source-mixing is again reduced.

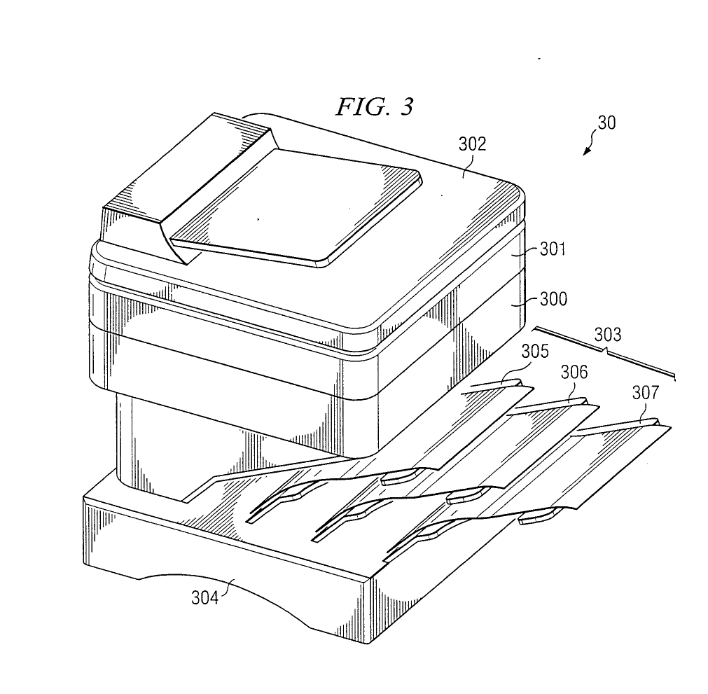

FIG. 3 is a perspective view illustrating printing device 30 configured with another embodiment of horizontal output array 303, as described herein. Printing device 30 is configured with print engine 300, scanner 301, and ADF 302 above output array 303. Input tray 304 feeds print engine 300 from the base of printing device 30. As paper gets printed from print engine 300, it is selectively output to one or more of trays 305-307 in output array 303.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A printing system comprising:
a plurality of output surfaces, wherein each of said plurality is attached to a mounting surface running substantially perpendicular to a height of said printing system and is offset horizontally from one another; and
wherein each of said plurality is shaped to provide user access to printed output and wherein said printed output is deposited to a specific one of said plurality of output surfaces responsive to a selection.

2. The printing system of claim 1 wherein said plurality of output surfaces are substantially parallel to one another.

3. The printing system of claim 1 wherein said plurality of output surfaces extend beyond a footprint of said printing system.

4. The printing system of claim 1 wherein said plurality of output surfaces are retractable.

5. The printing system of claim 1 further comprising:
a print engine for printing output of said printing system;
an input tray for storing and providing print media to said print engine; and
a scanner for capturing an image from an original to be copied.

6. The printing system of claim 5 wherein said plurality of output surfaces are disposed between one of:
said print engine and said input tray;
said input tray and said scanner; and
said scanner and said print engine.

7. The printing system of claim 5 further comprising:
an automatic document feeder.

8. The printing system of claim 1 wherein said printed output is deposited to one of said plurality of output surfaces dependent on an identification of a user requesting said printed output.

9. The printing system of claim 1 wherein said selection is a user-selection.

10. The printing system of claim 1 wherein said selection is a function of said printing device communicating said printed output.

11. A printing device comprising:
a plurality of output trays set apart from one another horizontally along a mounting surface running substantially parallel to a height of said printing device,
wherein printed output is deposited to a specific one of said plurality of output trays responsive to a selection.

12. The printing device of claim 11 wherein each of said plurality of output storage trays is substantially the same.

13. The printing device of claim 11 wherein said plurality of output trays extends beyond a footprint of said printing device.

14. The printing device of claim 11 wherein said plurality of output trays are foldable.

15. The printing device of claim 11 wherein said selection corresponds to a function of said printing device.

16. The printing device of claim 11 wherein said selection depends on a user requesting printing.

17. The printing device of claim 11 wherein said selection is a user-selection.

18. The printing system of claim 1 further comprising a high capacity output surface.

19. The printing system of claim 10 wherein said function is selected from a group comprising copying, faxing, and printing.

20. The printing device of claim 11 further comprising a high capacity output tray.

21. The printing device of claim 15 wherein said function is selected from a group comprising copying, faxing, and printing.
